(19) United States
(12) Patent Application Publication
(10) Pub. No.: US 2006/0075804 A1
(43) Pub. Date: Apr. 13, 2006

(54) Engine water cooling system leaking tester

(76) Inventor: Hsin Fa Kang, Tainan City (TW)

Correspondence Address: Hsin Fa Kang, P.O. BOX 90, Tainan City, 70499, TW

(21) Appl. No.: 10/961,027

(22) Filed: Oct. 12, 2004

(51) Int. Cl. G01M 3/04

(52) U.S. Cl. 73/40

(57) ABSTRACT

An engine water cooling system leaking tester includes large-sized, medium-sized and small-sized gripping pliers respectively employed for clamping plastic pipes of different diameters in an engine cooling system, and a tester provided with a pressure gauge, having one end fixed with an adapter provided thereon with a switch pull lever and the other end fitted with a duct having its end connected with a high-speed adapter for connecting a large-sized and a small-sized connecting pipe. Thus, after one end of a water pipe is clamped by the appropriate gripping pliers and disassembled, the other end of the water pipe is connected with the connecting pipe that is connected with the tester for carrying out leaking test. This tester is applicable to different-typed automobiles.

### BACKGROUND OF THE INVENTION

1. Field of the Invention

This invention relates to an engine water cooling system leaking tester, particularly to one including a pair of large-sized pliers, a pair of medium-sized pliers, a pair of small-sized gripping pliers, a tester, a large-sized connecting pipe and a small-sized connecting pipe. The large-sized, the medium-sized and the small-sized pliers are respectively employed for clamping plastic pipes of different diameters in an engine cooling system. The tester is provided with a pressure gauge, having one end fixed with an adapter provided thereon with a switch pull lever and the other end provided with a connecting pipe having its outer end fixed with a high-speed adapter for connecting the large-sized and the small-sized connecting pipe. Thus, after one end of a water pipe is clamped by the gripping pliers and disassembled, the other end of the water pipe is connected with the connecting pipe that is connected with the tester to carry out leaking test of the pipe. The engine water-cooling system leaking tester in this invention is applicable to different-typed automobiles.

2. Description of the Prior Art

As commonly known, an automobile engine water cooling system is mainly for preventing the temperature of an operating engine from becoming excessively high so as to maintain safety of the automobile. If cracks should happen to any of the water pipes in an engine cooling system, cooling water in the pipes is easy and quick to run off and the temperature of the engine will become excessively high, liable to endanger the running automobile. Therefore, when the temperature of the engine becomes excessively high, what should be done first is to inspect whether there is water still remaining in the water tank. In case water in the water tank is found running off too fast, it is necessary to inspect whether there is any crack in the pipes of the engine cooling system.

A conventional water tank leaking tester 1, as shown in FIG. 1, includes a water tank (A10) having a water tank opening (A11) formed in the topside, and a inspecting cover 10 threadably assembled on the water tank opening (A11) and having an adapter 11 extending upward for connecting a high-speed adapter 12, which has the other end fixed with a connecting pipe 13 having its upper end provided with a hand pressing pump 15 with a pressure gauge 14. In using, air is pumped into the water tank (A10) by the hand-pressing pump 15 for observing whether there is leakage of air and pressure through the pressure gauge 14. If leakage should happen, an experienced mechanic is able to find where a pipe is broken and then have it disassembled and replaced with a new one. However, to match with different-sized water tank covers of various kinds of automobiles, it is necessary to provide various types of conventional water tank leaking testers 1 with different-sized inspecting covers 10, thus increasing purchase cost and unable to use one kind of the outfit for all types of automobiles.

### SUMMARY OF THE INVENTION

The objective of the invention is to offer an engine water-cooling system leaking tester applicable to different-typed automobiles.

The engine water-cooling system leaking tester in the present invention includes the following components:

a pair of large-sized gripping pliers for clamping an upper or a lower cooling liquid plastic pipe arranged in an engine cooling system;

a pair of medium-sized gripping pliers for clamping the cooling water pipe arranged in the engine cooling system;

a pair of small-sized gripping pliers for clamping the exhaust pipe of the engine cooling system;

a tester provided with a pressure gauge, having one end fixed with an adapter provided thereon with a switch pull lever and the other end connected with a duct having its end fitted with a high-speed adapter;

a large-sized connecting pipe having one end fitted with the duct of the tester and the other end connected with the cooling water pipe; and, a small-sized connecting pipe having one end fitted with the duct of the tester and the other end connected the exhaust pipe.

### BRIEF DESCRIPTION OF DRAWINGS

This invention will be better understood by referring to the accompanying drawings, wherein:

FIG. 1 is an exploded perspective view of a conventional water tank-leaking tester;

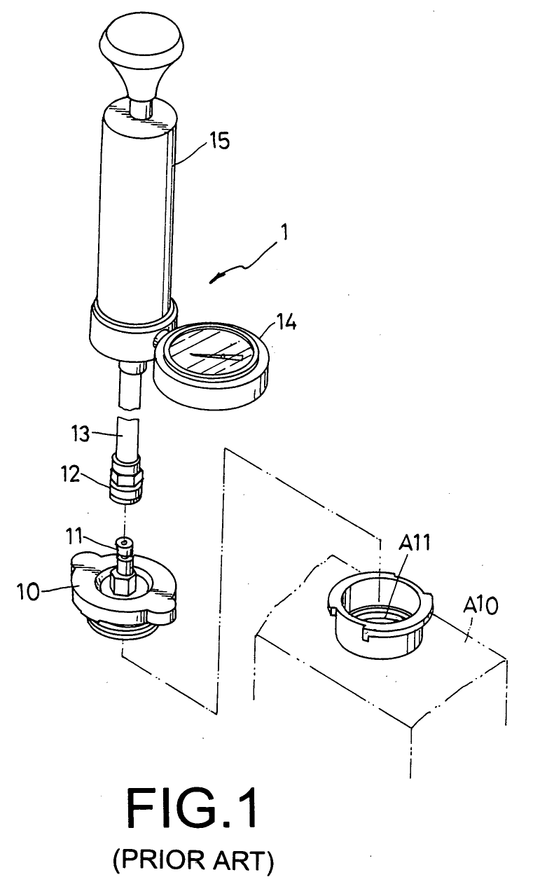

FIG. 2 is a front view of an engine water-cooling system leaking tester in the present invention;

FIG. 3 is an exploded perspective view of the engine water-cooling system leaking tester in the present invention;

FIG. 4 is a perspective view of the engine water-cooling system leaking tester in an operating condition of testing all the pipes in the present invention;

FIG. 5 is a perspective view of the engine water cooling system leaking tester in an operating condition for testing the pipe route of the engine in the present invention; and,

FIG. 6 is a perspective view of the engine water-cooling system leaking tester in an operating condition for testing an individual pipe in the present invention.

### DETAILED DESCRIPTION OF THE PREFERRED EMBODIMENT

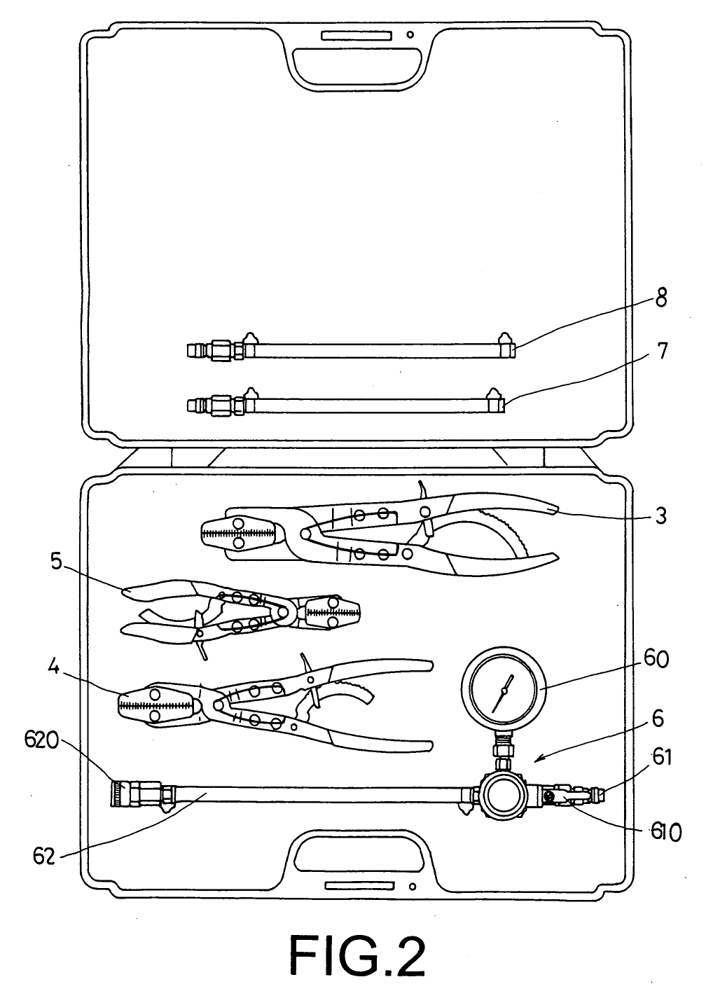

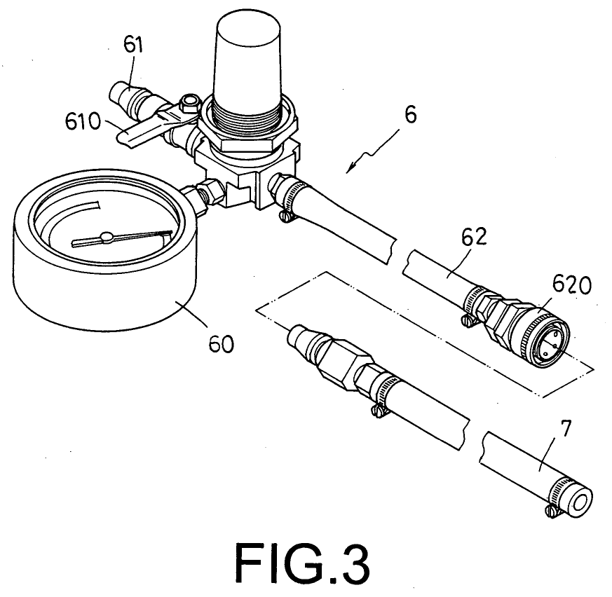

A preferred embodiment of an engine water cooling system leaking tester in the present invention, as shown in FIGS. 2, 3 and 4, includes a pair of large-sized gripping pliers 3, a pair of medium-sized gripping pliers 4, a pair of small-sized gripping pliers 5, a tester 6, a large-sized connecting pipe 7 and a small-sized connecting pipe 8 combined together.

The large-sized, the medium-sized and the small-sized gripping pliers 3, 4, 5 are respectively employed for clamping different-sized pipes arranged in an engine cooling system 2. The pipes arranged in the engine cooling system 2 include an upper and a lower cooling liquid plastic pipe 21, 22 respectively connected with a radiator 20 provided with fans 200, and the exhaust pipe 23 of the radiator 20. The exhaust pipe 23 of the radiator 20 is connected with a cooling water tank 24 and the exhaust pipe 25 of a motor. The cooling water tank 24 is connected to the water pipe 28 of a water pump 27 by means of a cooling water pipe 26.

The tester 6 is provided with a pressure gauge 60 at one side, having one end fixed with an adapter 61 fitted thereon with a switch pull lever 610 and the other end fitted with a duct 62 having its outer end fixed with a high-speed adapter 620 for connecting the large-sized connecting pipe 7 or the small-sized connecting pipe 8.

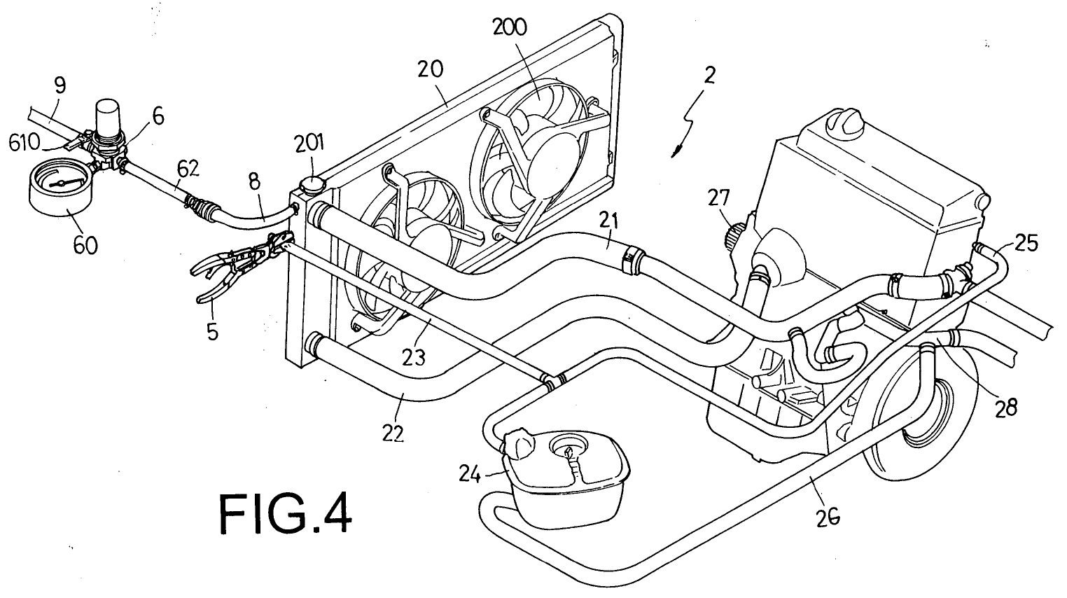

Leaking test of the water pipes arranged in the engine cooling system 2 includes the following three processes, as shown in FIGS. 4, 5 and 6:

1. The first process of leaking test for all the pipes in the engine cooling system, as shown in FIG. 4: Firstly, one end of the exhaust pipe 23, which is connected with one side of the radiator 20, is clamped by the small-sized gripping pliers 5 and then disassembled from the radiator 20. Next, the small-sized connecting pipe 8 is made to have one end connected with the duct 62 of the tester 6 and the other end connected with a side hole near the cover 201 of the radiator 20. Subsequently, an air-pumping pipe 9 is connected with the adapter 61 of the tester 6 and pumps air into the pipes. After the pipes are filled with air, turn the switch pull lever 610 to stop exterior air from getting in the pipes and then observe whether the index hand of the pressure gauge 60 is turned backward or not. If the index hand of the pressure gauge 60 is turned backward, it indicates that certain pipe in the engine cooling system 2 is broken and leaks.

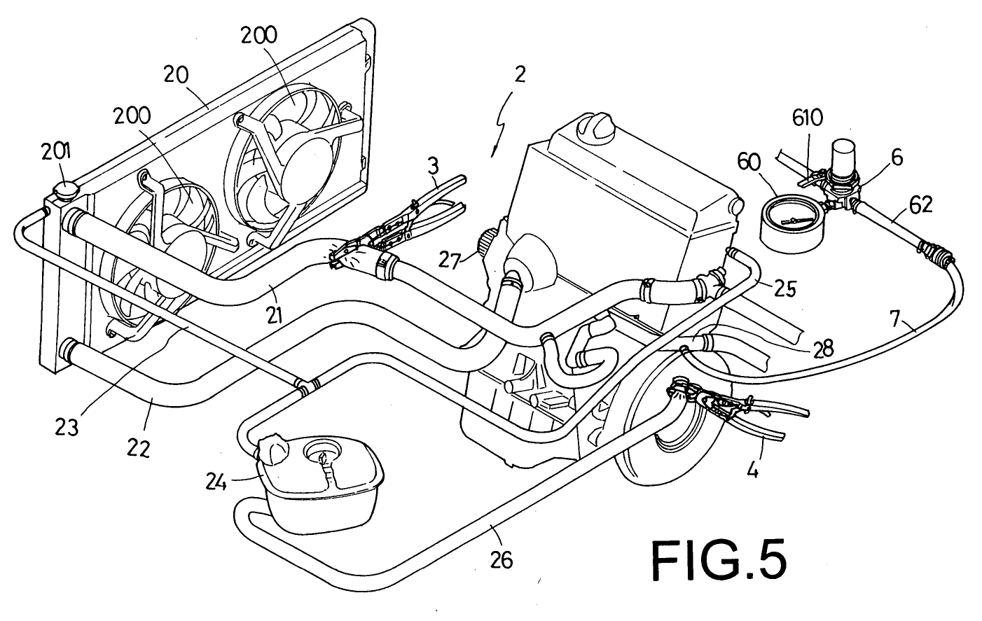

2. The second process of leaking test of the pipes of the engine, as shown in FIG. 5: Firstly, the upper cooling liquid plastic pipe 21 is clamped by the large-sized gripping pliers 3 and one end of a cooling water pipe 26 connected with the cooling water tank 24 is clamped by the medium-sized gripping pliers 4. Next, the end of the cooling water pipe 26, which is connected with a water pipe 28, is detached from the water pipe 28 and connected with the large connecting pipe 7 that is connected with the tester 6, thus able to carry out leaking test of the pipes of the engine.

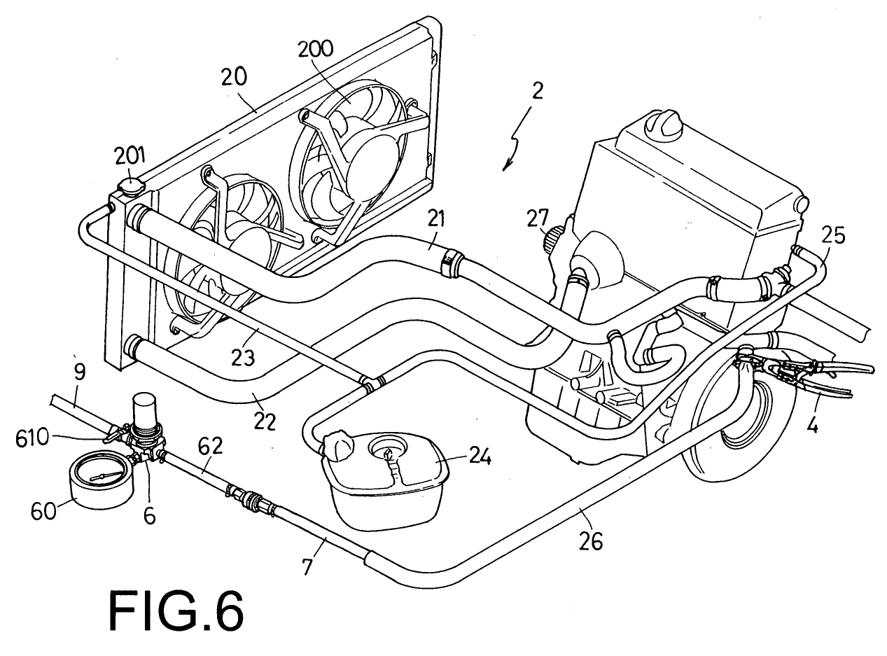

3. The third process of leaking test for a certain section of an individual pipe, as shown in FIG. 6: To carry out leaking test for the cooling water pipe 26, for instance, the cooling water pipe 26 has one end clamped by the medium-sized gripping pliers 4 and the other end connected with the large-sized connecting pipe 7 that is connected with the duct 62 of the tester 6. Then, pump in air to test whether the cooling water pipe 26 is broken and leaks.

Apparently, the large-sized, the medium-sized and the small-sized gripping pliers 3, 4, 5 can be optionally employed for clamping the plastic pipes of different diameters in the engine cooling system 2, and then one of these pipes is connected with the tester 6 for being tested for leaking. Therefore, the engine water-cooling system leaking tester in this invention is applicable to different-typed automobiles, unnecessary to purchase special leaking testers of different sizes, able to be operated conveniently and having great practicability as well as economic gain.

While the preferred embodiment of the invention has been described above, it will be recognized and understood that various modifications may be made therein and the appended claims are intended to cover all such modifications that may fall within the spirit and scope of the invention.

What is claimed is:

1. An engine water-cooling system leaking tester comprising:
a pair of large-sized gripping pliers for clamping an upper or a lower cooling liquid plastic pipe arranged in an engine cooling system;
a pair of medium-sized gripping pliers for clamping a cooling water pipe arranged in said engine cooling system;
a pair of small-sized gripping pliers for clamping an exhaust pipe arranged in said engine cooling system;
a tester provided with a pressure gauge, said tester having one end fixed with an adapter, said adapter provided thereon with a switch pull lever, said tester having the other end fixed with a duct, said duct having its outer end connected with a high-speed adapter;
a large-sized connecting pipe having one end connected with said duct of said tester, said large-sized connecting pipe having the other end connected with said cooling water pipe;
a small-sized connecting pipe having one end connected with said duct of said tester, said small-sized connecting pipe having the other end connected with said exhaust pipe; and,
said small-sized gripping pliers clamping said exhaust pipe connected with a side hole beside the cover of a radiator, said exhaust pipe having its adapter disconnected from said side hole of said radiator, said small-sized connecting pipe having one end connected with said duct of said tester, said small-sized connecting pipe having the other end connected with said side hole of said radiator, thus able to carry out leaking test for all the pipes in said engine cooling system, to carry out leaking test for an individual water pipe of different sections, the pipe to be tested having end clamped by said medium-sized gripping pliers, said pipe to be tested having the other end connected with said large-sized connecting pipe that is connected with said tester, thus said individual pipe able to be tested for leaking, said engine water cooling system leaking tester applicable to different-typed automobiles.
